(19) United States
(12) Patent Application Publication
(10) Pub. No.: US 2008/0228853 A1
(43) Pub. Date: Sep. 18, 2008

(54) SOFTWARE SYSTEM

(75) Inventors: Poul-Jorgen Brinck, Snekkersten (DK); Henrik Holm, Carrasco (DK); Stig Holm, Carrasco (UY); Henrik Holm, Carrasco (UY); Alejandro Esteban Cortes, Buenos Aires (AR); Miguel Angel, Khouri Veron, Buenos Aires (AR); Jonathan Smirnoff, Buenos Aires (AR); Federico Felman, Buenos Aines (AR); Juan Ignacio Porta, Bernal (AR); Silvio Augusto Massari, Buenos Aires (AR); Pablo Dario Zaidenvoren, Buenos Aires (AR); Matias Gabriel Malbergier, Buenos Aires (AR); Lucas Campos, Haedo (AR); Gabriela Mabel Gadda, Castelar (AR); Ariel Martin Neisen, Buenos Aires (AR); Edgardo Burke, Buenos Aires (AR); Julian Cantore, Buenos Aires (AR); Gaston Sanchez, Castelar (AR); Alejandro Andres Bologna, Villa Madero (AR); Diego Gonzalez, Ramos Mejia (AR)

Correspondence Address: BUCHANAN, INGERSOLL & ROONEY PC, POST OFFICE BOX 1404, ALEXANDRIA, VA, 22313-1404, US

(73) Assignee: KAYXO DK A/S, Hoersholm (DK)

(21) Appl. No.: 11/945,279

(22) Filed: Nov. 27, 2007

Related U.S. Application Data
(60) Provisional application No. 60/918,054, filed on Mar. 15, 2007.

(51) Int. Cl. G06F 15/16

(52) U.S. Cl. 709/201

(57) ABSTRACT

A software system including at least one MAPI client component, a model adapter, and a model sub system. The MAPI client component(s) operate in a COM environment, the model adapter operates partly in the COM environment and partly in a .NET environment, and the model sub system operates partly or fully in the .NET environment. The MAPI client component(s), the model adapter, and the model sub system are arranged to communicate with each other.

### TECHNICAL FIELD

The invention relates to a Software System for facilitating communication and establishment of the communication with Corporate Systems, such as financial systems via a MAPI Client such as Outlook®, where the communication for example comprises presenting or managing corporate data.

### BACKGROUND ART

Businesses and other organizations are continuously investing large sums of money in IT systems for data handling systems and other Corporate Systems for handling, calculating or in other ways computerizing various data. For example it could be mentioned that most organizations have a financial management system such as Oracle Financials or Microsoft Dynamics NAV.

In a similar way various organizations comprise various other data handling systems such as Intellectual Property management systems, Personnel management systems, Stock management systems, Customer management systems and Production management systems. These IT systems which in the following will be referred to as Corporate Systems are typically standard systems that are customized to the organization's objectives and business processes.

Most of these IT systems are providing significant business benefits in terms of time and money saved, higher quality in work done, and better decision making. But, in spite of these benefits, most organizations agree that they aren't leveraging the full potential of such IT systems merely because the systems aren't properly integrated with each other and because they aren't properly integrated with desktop productivity tools like Microsoft Office. In general Corporate Systems are arranged to run side by side with Microsoft Office and in general there is no simple way available to provide a smooth and ongoing communication between such Corporate Systems and Microsoft Outlook® without requiring large processing capability for transferring whole Corporate System databases or reprogramming the Corporate Systems to be capable of communication with Microsoft Outlook®.

A common setup on the information worker's desktop is a multitude of IT applications, each with a different set of user interface semaphores running side by side. Information workers switch between applications copying and pasting data, spending unnecessary time completing their tasks. Learning curves are high and desktop routines are inefficient.

For instance if the sales manager is receiving an email with a claim for a delayed order, he will have to switch to the Customer Corporate System to see if there are other pending orders for the customer, if there are other claims in the Help Desk system and etc.

Generally it is difficult to provide a communication with a MAPI Client Component such as Outlook®. MAPI clients are provided in a COM Environment which is a very difficult environment for most programmers to work in.

Communication with a MAPI Client can for certain simple and prearranged communication be made indirectly via a simple interface such as an API client interface. However, the API interface is designed for less complex messaging-enabled and -aware applications only and the full Extended MAPI interface is required for more complicated communications such as messaging-based applications.

Many Corporate Systems are provided in other Environments that COM which in it self makes the communication over a MAPI interface difficult. However, even for Corporate System provided in a COM Environment, the prior art does not provide any simple method to provide an integration between such systems and Microsoft Outlook®.

US patent application No. 2006/0069684 (Microsoft Corporation) describes a Smart Client System for providing a data communication between a base application, such as Microsoft Outlook®, and ad-in software, such as a Customer Relationship Management System e.g. a data structure that stores contact information for customers, sales history, service history, sales leads information.

The target application in the example is a CRM system from Siebel Systems, Inc. The Smart Client Addln will allow users to access CRM data in the Siebel CRM system using Microsoft Outlook®. In order to view the Siebel CRM system within the context of Microsoft Outlook® and navigate to desired view the current CRM objects need to be converted to Outlook® items. These conversions often require large amount of processing capability and time and often the user will observe delay in the access of the data. Furthermore the Corporate Systems are very difficult to connect to cooperate with Microsoft Outlook®.

US patent application No. 2002/0059325 (MordeChai) describes a method for structuring folders and a memory storing the folder structure. The Work Folder allows users of local or distributed data environments to gather and organize a collection of documents and supporting meta-data in a single data object that can be simultaneously accessed and updated by multiple users. However, in order to be displaced in a Work Folder according to this disclosed system the document must either be attached to a Work Folder and its contents stored within the Work Folder, or the Work Folder must be linked to an “external” document via a file system reference via an Open Document Management Application Program Interface (ODMA) link to a document management system.

US patent application NO. 2003/0200272 (Leon Campise) describes a system and method that utilizes ubiquitous software programs to permit users to provide input to specialized software programs without the need for modification of the ubiquitous software programs, without requiring the installation of any new software on the user's computer, and without requiring excessive user training.

The system for data collection comprising: a surrogate e-mail address; and a message server, the message server adapted to: receive the surrogate e-mail address; extract from the surrogate e-mail address one or more instructions directed to a specialized software program; extract from the surrogate e-mail address one or more data elements directed to the specialized software program; and process the instructions and the data elements extracted from the surrogate e-mail address for use by the specialized software program.

### DISCLOSURE OF INVENTION

The object of the invention is to provide a Software System which is relatively simple to set up for providing a fast and reliable communication between a MAPI client and a Corporate System over a MAPI interface.

The object of the invention has been achieved by the Software System as defined in the claims and as described herein below.

It should be emphasized that the term “comprises/comprising” when used in this specification is taken to specify the presence of stated features, integers, steps or components but does not preclude the presence or addition of one or more other stated features, integers, steps, components or groups thereof.

The term “Software System” is herein used to designate a system comprising an assembly of software components comprising a whole with each and every component interacting with or related to at least one other component. Any component which has no relationship with any other component of the system is not a software component of that system. A Software System may comprise other elements such as documents supporting one or more software components of the Software System. A Sub System is taken to mean one or more components e.g. a set of components, including at least one software component and which is a part of a whole system.

A MAPI Client Component is a software component that makes service requests through MAPI.

A Model Sub System is taken to mean a Sub System that provides the model of a software system domain, the domain being expressed through data classes and associations as it is well known to the skilled person. In one embodiment of the invention the Model Sub System comprises message stores, folders, messages, categories, recipients, and attachments with message stores being associated to multiple folders, folders being associated to multiple sub folders and multiple messages, and messages being associated to multiple categories, multiple recipients, and multiple attachments.

An adapter (sometimes referred to as a Wrapper in the art) is a software component which can adapt one application programming interface into another application programming interface. An adapter allows software components which without such an adaptor could not work together because of incompatible application programming interfaces, to work together by wrapping the service requesting component's application programming interface around the service providing component's application programming interface. Adaptors as such and the principle of adapting (wrapping) are known by the skilled person.

A Model Adapter is taken to mean an adapter between the MAPI Client Component and the Model Sub System. A Model Adapter facilitates the access of the model from the MAPI Client Component to the Model Sub System.

A Client Adapter is taken to mean an adapter between the MAPI Client Component and the Model Sub System. A Client Adapter adapts the MAPI Client Component user interface to comply with the capabilities of a particular Model Provider comprised in the Model Sub System. The Client Adapter may be accessed as desired e.g. upon a first request posted from said MAPI Client Component to said Model Adapter. A request to the Client Adapter may simultaneously be provided. In general it is desired that the Client Adapter may be accessed at any time.

A Corporate System is taken to mean any software system through which a response can be provided. A Corporate System may e.g. operate in the corporate network, be accessible over the internet or the intranet, and/or comprise software systems operating on a computer. As examples of Corporate Systems can be mentioned accounting systems, enterprise resource planning systems, customer relationship management systems, supplier relationship management systems, point of sales systems, production management systems, content management systems, any banking system, any social services system, any taxation system, and any utility management system. In general it is desired that the Corporate System comprises at least one Database.

A Model Provider is taken to mean a software component that provides a set of objects, such as instances of classes of the model of the software system domain.

A System Adapter is taken to mean an adapter between a Model Provider and a Corporate System. A System Adapter facilitates data access from the Model Provider to the Corporate System.

A Software Mediator is taken to mean a software component or a set of software components providing a unified interface to a set of interfaces in a Corporate System. Using the Software Mediator interface allows the MAPI Client Components to access the Corporate System without ever knowing their particular interfaces.

A Database is a structured collection of related data records stored on a storing device, such as a server or a computer. The data may preferably be stored in a way such that it can be queried.

A Relational Database is taken to mean a database that implements the relational model as defined by E. F. Codd in 1970. Products said to be relational databases comprise Microsoft SQL Server, Microsoft Access, MySQL, Oracle Database, IBM Informix, IBM DB2, Progress Open Edge, Sybase Adaptive Server, Sybase Open Server, Interbase, and Pervasive PSQL.

A Directory Service is taken to mean a software system that stores and organizes information about a computer network's users and resources and preferably allows network administrators to manage user's access to the resources. Like a database, a directory service may be highly optimized for reads and may provide advanced search on the many different attributes that can be associated with objects in a directory. The data that is stored in the directory may be defined by an extendible and modifiable scheme. A directory service may preferably use a distributed model for storing its information and that information is usually replicated between directory servers.

An XML-file is a file based repository for XML marked up data. XML, which is short for Extensible Markup Language, is a W3C-recommended general-purpose markup language that supports a wide variety of applications. XML languages or ‘dialects’ are easy to design and to process. XML is also designed to be reasonably human-legible, and to this end, terseness was not considered essential in its structure. XML is a simplified subset of Standard Generalized Markup Language (SGML). Its primary purpose is to facilitate the sharing of data across different information systems, particularly systems connected via the Internet. Formally defined languages based on XML (such as RSS, MathML, GraphML, XHTML, Scalable Vector Graphics, MusicXML and thousands of other examples) allow diverse software to reliably understand information formatted and passed in these languages.

User Interface Elements are visual elements of the MAPI Client Component's user's interface. User Interface Elements comprises any types of visual interaction points, such as dialog boxes, menus, tool bars, windows, window panes, graphs, user controls and other visual support for a user. COM, which is short for Component Object Model, is a Microsoft programming environment for software componentry introduced by Microsoft in 1993. It is used to enable inter-process communication and dynamic object creation in any programming language that supports the COM technology. The term COM is often used in the software development industry as an umbrella term that encompasses the OLE, OLE Automation, ActiveX, COM+ and DCOM technologies. Although COM was introduced in 1993, Microsoft did not begin emphasizing the term COM until 1997. The essence of COM is a language-neutral way of implementing objects such that they can be used in environments different from the one they were created in, even across machine boundaries. For well implemented components, COM allows reuse of objects with no knowledge of their internal implementation because it forces component implementers to provide well defined interfaces that are separate from the implementation. The different allocation semantics of programming languages are normally accommodated by making objects responsible for their own creation and destruction through reference counting. Casting between different interfaces of an object is often achieved through the QueryInterface( ) method. The preferred method of inheritance within COM is the creation of sub objects (called aggregation) to which method calls are delegated. To some extent COM is now depreciated in favor of .NET.

.NET, expressed dot-NET, is a Microsoft programming environment that can be added to the Microsoft Windows operating system. It provides a large body of pre-coded solutions to common program requirements and manages the execution of programs written specifically for the platform. The .NET platform is a key Microsoft offering and is intended to be used by most new applications created for the Windows platform. The pre-coded solutions in the namespaces form the platform's class library and cover a large range of programming needs in areas including the user interface, data access, cryptography, web application development, numeric algorithms, and network communications. The functions of the class library are used by programmers who combine them with their own code to produce applications. Programs written for the .NET platform execute in a software environment that manages the program's runtime requirements. This runtime environment, which is also a part of the .NET platform, is known as the Common Language Runtime (CLR). The CLR provides the appearance of an application virtual machine, so that programmers need not consider the capabilities of the specific CPU that will execute the program. The CLR also provides other important services such as security mechanisms, memory management, and exception handling. The class library and the CLR together compose the .NET platform. The platform is intended to make it easier to develop computer applications and to reduce the vulnerability of applications and computers to security threats. First released in 2002, .NET is now provided with Windows Server 2003 and Windows Vista, and versions up to and including 2.0 can be installed on older versions of Windows. The current version is 3.0, which was released in November 2006, and is supported on Windows XP Service Pack 2, Windows Server 2003 Service Pack 1, and Windows Vista.

A Third Environment may in principle be any kind of programming environment, such as programming environment comprising Windows with COM, Windows with .NET, MSDOS, Unix, Linux, OS/2, AS400, MVS, OS/390, and many more.

An Application Programming Interface (also known as an API) is a software interface that software components provide in order to provide service responses upon service requests made by other software components. The software component providing the services described by the interface is said to be an implementation of the interface. The Application Programming Interface itself is an abstract in that it specifies the interface only and does not get involved with implementation details.

MAPI is an acronym for Messaging Application Programming Interface implemented in Microsoft Windows. MAPI allows client programs to become messaging-enabled, -aware, or -based by calling MAPI subsystem routines that interface with messaging systems and message stores. MAPI refers to both client application messaging consumption and messaging information provision.

A Data Management Request is taken to mean a request to manage data. A Data Management Requests may preferably be selected from the group consisting of Data Count Requests, Data Select Requests, Data Insert Requests, Data Update Requests, Data Delete Requests and combinations thereof.

A Data Count Request is taken to mean a request to count the records in a specified set of records in a given dataset.

A Data Select Request is taken to mean a request to retrieve (select) a specified set of records from a given dataset.

A Data Insert Request is taken to mean a request to insert records into a given dataset.

A Data Update Request is taken to mean a request to update a specified set of records in a given dataset.

A Data Delete Request is taken to mean a request to delete a specified set of records from a given dataset.

A Data Management Response is taken to mean a response to a Data Management Request. A Data Management Response may preferably be selected from the group consisting of Data Count Responses, Data Select Responses, Data Insert Responses, Data Update Responses, Data Delete Responses and combination thereof.

A Data Count Response is taken to mean a response to a Data Count Request. A Data Count Response provides the count of records in a set of records specified in the request.

A Data Select Response is taken to mean a response to a Data Select Request. A Data Select Response provides the set of records specified in the request.

A Data Insert Response is taken to mean a response to a Data Insert Request. In synchronous computing environments, a Data Insert Response provides a status on the insert performed indicating whether or not the insert was successful.

A Data Update Response is taken to mean a response to a Data Update Request. In synchronous computing environments, a Data Update Response provides a status on the update performed indicating whether or not the update was successful.

A Data Delete Response is taken to mean a response to a Data Delete Request. In synchronous computing environments, a Data Delete Response provides a status on the delete performed indicating whether or not the delete was successful.

A State Change Signal signals a change in state. In one embodiment, the MAPI Client Component sends State Change Signals to the Client Adapter as users interact with it for example by selecting folders, opening folders, selecting messages, and/or opening messages. In one embodiment, State Change Signals come as Service Requests.

A Service Level Request is taken to mean a request to provide information about levels of services provided by a software component or a software sub system. Thereby a Software component and/or a software sub system can provide information about the service level it/they provide to enable software clients not to call for service levels not provided.

A Service Level Response is accordingly a response to a Service Level Request. The response informs about the level of services provided by an associated software component.

A Service Request is the act of requesting a service from a software component through well defined application programming interface. This includes the act of requesting the service level. A Service Request may preferably be selected from the group of Service Level Requests and service Management Requests.

A Service Response is the act of responding to a Service Request through a well defined application programming interface.

Communicating is the combined act of posting service requests and receiving service responses.

Adapting is taken to mean the act of transforming the format of service requests and service responses while preserving the content of these requests and responses. When two computing environments or components using different formats want to communicate on similar content, adapting is used to facilitate the communication.

Processing is taken to mean the act of altering or discriminating upon. Data is typically processed by altering its content or by reading it to detect conditions used for discriminating other processing.

Providing is the act of bringing forward regardless of means. Responses to requests may for example be provided thru sourcing in databases, thru calculations, and thru combinations hereof.

Decomposing is taken to mean the act of breaking a whole into at least two smaller but correlated pieces.

Composing is taken to mean the act of combining at least two smaller and correlated pieces into a bigger whole.

Synchronizing is taken to mean the act of communicating two systems until an adaptation of a selected subset of data contained in both systems is equal.

Configurable is taken to mean the ability to change behavior based on data, known as configuration.

Extensible is taken to mean the ability to change or extend behavior based on other software components. It is normally said that components are plugged-in to the extensible component, thereby changing and extending its behavior.

Subscribing is the act of registering into a Software System in order to receive Service Requests according to events processed by that Software System.

In one embodiment the Software System of the invention comprises a SOA comprising at least one of a Service Provider, a Service Broker and a Service Requestor.

Service-oriented architecture (SOA) is an architectural style where existing or new functionalities are packaged as services. These services can communicate with each other by passing data from one service to another, or by coordinating an activity between one or more services.

Web services can be used to implement a service-oriented architecture. A major focus of Web services is to make functional building blocks accessible over standard Internet protocols that are independent from platforms and programming languages. These services can be new applications or just wrapped around existing legacy systems to make them network-enabled. Each SOA building block can play one or more of three roles: Service Provider, Service Broker and Service Requestor.

A Service Provider creates a Web service and possibly publishes its interface and access information to a Service Broker. Each Service Provider can decide which services to expose, what category the service should be listed in for a given Service Broker and what sort of agreements are required to use the service.

A Service Broker is responsible for making the Web service interface and implementation access information available to any potential Service Requestor. Public Service Brokers are available through the Internet, while private Service Brokers are only accessible to a limited audience, for example, users of a company network.

A Service Requestor or Web service client locates entries in the Service Broker registry using various find operations and then binds to the Service Provider in order to invoke one of its Web services.

The Universal Description Discovery and Integration (UDDI) specification defines a way to publish and discover information about Web services.

The SOA architecture may be implemented using a wide range of technologies other than Web Services, including but not limited to SOAP, RPC, DCOM, CORBA or WCF which are known technologies to the skilled person.

The Software System of the invention provides a novel and useful system by use of which a user can access a desired Corporate System via a MAPI Client Component such as Outlook®. As it will be clear from the claims and the following description, the Software System may be arranged such that the user may have access both to view and to manage, e.g. insert, update and/or delete data from the Corporate System thru the MAPI Client Component.

Microsoft Outlook® is a preferred MAPI Client Component. Microsoft Outlook® is generally known by users and it has a user interface which allows users to view and manage data in very complex yet easily understandable ways. The Outlook® structure comprising folders which by a simple click can be opened and closed is highly desired among users. Furthermore Microsoft Outlook® comprises several other desirable tools for manage data. By using the Software System of the invention a user can access a Corporate System via Outlook®, and consequently the user need not use time and effort learning to access the Corporate System by another often complicated user interface. In particular for users who only need access to a part of the functions of a Corporate System, and e.g. a user who needs to work with other systems (e.g. the mail system or other Corporate Systems) than the Corporate System simultaneously, the Software System of the invention is highly advantageous.

The Software System of the invention has been found to provide a new and beneficial solution for managing corporate data inside MAPI Clients. The Software System builds upon well known prior art systems. Due to the solution provided by the invention the implementation of the solution for managing corporate data inside MAPI Clients has been provided. The Software System of the invention may thus accelerate a few MAPI experts and enables the majority of programmers to implement MAPI interfaces in the .NET programming environment thereby rapidly creating solutions for managing corporate data from an array of corporate systems inside MAPI Clients such as Microsoft Outlook®.

The Software System of the invention may be built up in components, which is facilitate integrating in exciting systems, and further more makes it easier to adapt to the desired user. The Software System of the invention comprises at least one MAPI Client Component, a Model Adapter, and a Model Sub System, the MAPI Client Component(s) operates in COM Environment. The Model Adapter operates partly in COM Environment and partly in .NET Environment. The Model Sub System operates partly or fully in .NET Environment, and the MAPI Client Component(s). The Model Adapter and the Model Sub System are arranged to communicate with each other e.g. as described further on.

Usually the Model Sub System comprises at least one Database, for example in the form of a Database of a Corporate System constituting a part of the Model Sub System.

In order to adapt the MAPI Client Component(s) user interface to the capabilities of the Model Sub System the Software System of the invention may preferably further comprise at least one Client Adapter. The Client Adapter(s) operates partly in the COM Environment and partly in the .NET Environment. The MAPI Client Component(s), the Client Adapter, and the Model Sub System are preferably arranged to communicate with each other, so that the user interface as described above may be adapted to comply with the capabilities of the Model Provider, and possibly the capabilities of one or more connected Corporate Systems.

In one embodiment the Client Adapter is arranged such that whenever in time an event (state change) occurs in the MAPI Client Component, the Client Adapter will assess the new state and understand what underlying model providers may successively be invoked by the user. Based on these model providers capabilities, the users' interface may be adapted (altered) to prevent the user from performing actions which otherwise would have resulted in request being sent to the model providers for which there is no support.

In one embodiment wherein the Software System comprises a Client Adapter the communication may be provided as follows: The MAPI Client Component(s) is capable of posting at least one State Change Signal to the Client Adapter. The Client Adapter is capable of receiving the State Change Signal(s) posted from the MAPI Client Component(s), of reacting to the State Change Signal(s) received by posting at least one Service Level Request to the Model Sub System. The Model Sub System is capable of receiving the Service Level Request(s) posted from the Client Adapter(s), of providing at least one Service Level Response in response to the Service Level Request(s) received, and of posting the provided Service Level Response(s) to the Client Adapter. The Client Adapter is capable of receiving the Service Level Response(s) posted from the Model Sub System, and of augmenting, altering, and/or diminishing at least one User Interface Element of the MAPI Client Component(s) based on the Service Level Response(s) received.

In one embodiment the MAPI Client Component(s) is capable of posting at least one Data Management Request to the Model Adapter via a MAPI. The Model Adapter is capable of receiving the Data Management Request(s) posted from the MAPI Client Component(s), of adapting the Data Management Request(s) received, and of posting the adapted Data Management Request(s) to the Model Sub System. The Model Sub System is capable of receiving the Data Management Request(s) posted from the Model Adapter and of processing the Data Management Request(s) received.

The expression that a component is capable of an action is taken to mean that the component is arranged to perform such action upon activation from a user or another software component. The method of performing the action as well as the programming structure and language for performing the action may in principle be any method, structure and/or language.

A beneficial feature of embodiments of the Software System of the invention is that due to the structure of the components and the communication via request-response and adapting of such request-response, the system can work very fast since only the requests and responses need to be adapted and not large amounts of other data.

In one embodiment of the Software System of the invention the Model Sub System is capable of providing at least one Data Management Response in response to the Data Management Request(s) received and of posting the provided Data Management Response(s) to the Model Adapter, The Model Adapter is capable of receiving the Data Management Response(s) posted from the Model Sub System, of adapting the Data Management Response(s) received, and of posting the adapted Data Management Response(s) to the MAPI Client Component(s) via the MAPI. The MAPI Client Component(s) is capable of receiving the Data Management Response(s) posted from the Model Adapter and of processing the Data Management Response(s) received.

The Data Management Request(s) and Response(s) may e.g. be as described above.

The Model Sub System may preferably comprise at least one Model Provider, at least one System Adapter, and at least one Corporate System. In principle the components of the Model Sub System may be more or less integrated with each other. The model Provider(s) operates in the .NET Environment, and the System Adapter(s) operates partly or fully in the .NET Environment and optionally partly in a Third Environment as described above. The Corporate System(s) operates at least partly in the .Net Environment or at least partly in the Third Environment.

In one embodiment the System Adaptor(s) or at least one System Adapter is partly or fully integrated into the Corporate System(s). In this system the Model Provider(s) may preferably be capable of receiving at least one Service Request selected from the group consisting of the Data Management Request(s) and the Service Level Request(s) and posted from the Model Adapter or the Client Adapter respectively, of decomposing and adapting the Service Request(s) received, and of posting the decomposed and adapted Service Request(s) to the Corporate System(s), and the Corporate System(s) may preferably be capable of receiving the Service Request(s) posted from the Model Provider(s), and of processing the Service Request(s) received.

Accordingly, the Corporate System(s) may preferably be capable of providing at least one Service Response in response to the Service Request(s) received, and of posting the provided Service Response(s) to the Model Provider(s), and the Model Provider(s) may preferably be capable of receiving the Service Response(s) posted from the Corporate System(s), of adapting the Service Request(s) received, of composing the Service Response(s) adapted, and of posting the composed Service Response(s) to the Model Adapter or the Client Adapter.

The Service Request(s) and Response(s) may be as described above.

In one embodiment of the Software System of the invention the Model Provider(s) is capable of receiving at least one Service Request selected from the group consisting of the Data Management Request(s) and the Service Level Request(s) and posted from the Model Adapter or the Client Adapter respectively, of decomposing the Service Request(s) received, and of posting the decomposed Service Request(s) to the System Adapter(s). The System Adapter(s) is capable of receiving the Service Request(s) posted from the Model Provider(s), of adapting the Service Request(s) received, and of posting the adapted Service Request(s) to the Corporate System(s). The Corporate System(s) is capable of receiving the Service Request(s) posted from the System Adapter(s), and of processing the Service Request(s) received. As it should be clear from the above description one request may be decomposed to two or more decomposed requests, such as 3, 4 or even more decomposed request.

In one embodiment the Software System of the invention is capable of providing at least one Service Response in response to the Service Request(s) received, and of posting the provided Service Response(s) to the System Adapter(s). The System Adapter(s) is capable of receiving the Service Response(s) posted from the Corporate System(s), of adapting the Service Response(s) received, and of posting the adapted Service Response(s) to the Model Provider(s). The Model Provider(s) is capable of receiving the Service Response(s) posted from the System Adapter(s), of composing the Service Response(s) received, and of posting the composed Service Response(s) to the Model Adapter or the Client Adapter. As it should be clear from the above description two or more, such, as 3, such as 4 or even more responses may be composed to one composed request.

In one embodiment wherein one Service Request is decomposed to x decomposed Service Requests, and y Service Responses are composed to one Service Response to said one Service Request, x and y may preferably be an identical integer.

The Software System of the invention may in one embodiment comprise two or more System Adapters, such as n System Adapter in communication with each other. n is an integer and may be 2 or more such as 3, 4, 5, 6 or even more. A first System Adaptor may e.g. be capable of receiving the Service Request(s) posted from the Model Provider(s) and of posting the received Service Request(s) to another System Adaptor. The Service Request(s) is thereafter posted to and received by a total of n System Adaptors, and at least one of the System Adaptors is capable of adapting the Service Request(s). The n'th System Adaptor is capable of posting the adapted Service Request(s) to the Corporate System(s).

In one embodiment all of the System Adapters except the n'th being able to process and return. Preferably all the System Adapters are able to process and return.

In the Software System with n System Adapters the Corporate System(s) may preferably be capable of providing at least one Service Response in response to the Service Request(s) received, and of posting the provided Service Response(s) to the n'th System Adaptor. The n'th System Adaptor is capable of receiving the Service Response(s) posted from the Corporate System(s) and of posting the received Service Response(s) to another System Adaptor. The Service Response(s) is posted to and received by the n System Adaptors, and at least one of the System Adaptors is capable of adapting the Service Response(s) received. The first System Adaptor is capable of posting the adapted Service Response(s) to the Model Provider(s).

The Service Request(s) and Response(s) may be as described above.

In one embodiment the Model Adapter has configurable behavior, and comprises at least one configuration scheme for the Model Adapter, and configuration for the Model Adapter preferably is retrieved from at least one source chosen from the group of messages, XML-files, Directory Services, and Relational Databases.

In one embodiment the Client Adapter has configurable behavior, and comprises at least one configuration scheme for the Client Adapter, and configuration for the Client Adapter preferably is retrieved from at least one source chosen from the group of messages, XML-files, Directory Services, and Relational Databases.

The configuration scheme for the Client Adapter may preferably be publicized.

In one embodiment at least one Model Provider has configurable behavior, and comprises at least one configuration scheme for the Model Provider(s), and configuration for the Model Provider(s) preferably is retrieved from at least one source chosen from the group of messages, XML-files, Directory Services, and Relational Databases.

The configuration scheme for the Model Provider(s) may preferably be publicized.

In one embodiment at least one System Adapter has configurable behavior, and comprises at least one configuration scheme for the System Adapter(s), and configuration for the System Adapter(s) preferably is retrieved from at least one source chosen from the group of messages, XML-files, Directory Services, and Relational Databases.

The configuration scheme for the System Adapter(s) may preferably be publicized.

By providing one or more of the software components with configurable behavior the Software System of the invention may be very simple to configure with any other desired software components. Configuration provides the Software System with easy to configure component behavior and with easy to configure component assembly into entire solutions.

In one embodiment the Model Adapter has extensible behavior and extensions for the Model Adapter operating in the .NET Environment and communicating with the Model Adapter via at least one Application Programming Interface.

In one embodiment the Client Adapter has extensible behavior and extensions for the Client Adapter operating in the .NET Environment and communicating with the Client Adapter via at least one Application Programming Interface.

In one embodiment at least one of the Model Provider(s) has extensible behavior and extensions for the Model Provider(s) operating in the .NET Environment and communicating with the Model Provider(s) via at least one Application Programming Interface.

In one embodiment at least one of the System Adapter(s) has extensible behavior and extensions for the System Adapter(s) operating in the .NET Environment and communicating with the System Adapter(s) via at least one Application Programming Interface.

By providing one or more of the software components with extensible behavior the Software System of the invention may be very simple to be extended with any other desired software components. The purpose of extensibility is to provide flexible component assembly into entire solutions and to provide flexible means for altering component behavior.

The MAPI Client may in principle be any kind of MAPI client capable of posting a request to the Model Adapter via the MAPI. The MAPI Client may preferably be a Fat Client, i.e. a client which is capable of processing the data received.

In one embodiment the MAPI Client is Microsoft Outlook®. Any versions of Microsoft Outlook® may be used. It is envisaged that also future Microsoft Outlook® version may be used in the present invention.

The MAPI Client Component(s) may preferably be selected from the group of Microsoft Outlook®, QUALCOMM Eudora®, Novell Groupwise®, and Mozilla Thunderbird®.

In one embodiment the MAPI Client Component(s) may preferably be selected from the group of Microsoft Outlook® 2000, Microsoft Outlook® XP, Microsoft Outlook® 2003, and Microsoft Outlook® 2007.

The Corporate System may reside internally or externally to the user, e.g. on the same computer, on a server connected to the computer or in principle anywhere provided that a connection can be provided. In one embodiment the Corporate System resides on the same computer, the same laptop or desktop, upon which the user is running the MAPI Client Component. Examples are local Access databases, spreadsheets, CSV files, and other secondary sources.

As mentioned above the one or more Corporate System(s) may in principle be any kind of software systems. Examples of Corporate Systems comprise Microsoft SQL Server®, Microsoft Access®, Microsoft Dynamics CRM®, Microsoft Dynamics AX®, Microsoft Dynamics NAV®, Microsoft Dynamics GP®, Microsoft Dynamics Point of Sale®, Microsoft Dynamics RMS®, Microsoft Dynamics SL®, Microsoft SharePoint®, Microsoft Active Directory Server®, Oracle PeopleSoft®, Oracle Siebel®, Oracle JD Edwards®, SAP®, mySAP®, SAP Business One®, SAP NetWeaver®, DUET®, IBM DB2®, IBM DB2 Common Store®, IBM DB2 Content Manger®, IBM DB2 Content Manger OnDemand®, IBM DB2 Document Manger®, IBM DB2 Warehouse®, IBM FileNet®, IBM OMNIFind®, IBM Lotus Notes®, IBM Lotus Domino®, IBM Rational Suite®, IBM Tivoli®, IBM WebSphere® and IBM Workplace®.

The Software System of the invention may preferably comprise a buffer, i.e. a region of memory used to temporarily hold output or input data. Buffers are generally used when there is a difference between the rate at which data is received and the rate at which it can be processed, or in the case that these rates are variable.

The buffer may have several effects, such as to reuse responses to requests recently posted avoiding requesting corporate systems over corporate networks too often. Buffer-time-to-live thresholds determine when a buffer is too old to be reused. The buffer may also have the effect of avoiding composing multiple Data Select Responses into a single view. Some MAPI Client Components use the method of composing responses which when requesting data from Corporate Systems will result in what is known as phantom and duplicate records. By posting and buffering Data Select Requests the size of or greater than the composed result, smaller Data Select Requests may be responded to by sourcing from the buffer and phantom and duplicate records may be avoided.

The Software System of the invention may comprise a database residing on a user's computer normally referred to as an off-line store to persistently hold output and/or input data. Offline stores are generally used to allow MAPI Client Components providing limited operation capabilities while connectivity to Corporate Systems is unavailable. This is known as operating in off-line mode. At any given point in time where connectivity with the Corporate System(s) is re-established by the MAPI Client Component(s) operating in off-line mode, they may synchronize the data in the off-line store with the data in the Corporate System(s), thus resuming the normal mode of operation, known also as on-line mode.

In one embodiment the Software System of the invention comprises one or more off-line stores and have the ability to operate in on-line or off-line mode with one or more Corporate System(s) respectively or simultaneously.

In one embodiment the Software System of the invention comprises one or a set of software components communicating with each other and capable of receiving at least one Data Management Request from a MAPI Client Component in a COM Environment via a MAPI (Messaging Application Programming Interface) and of adapting the Data Management Request(s) into at least one corresponding Data Management Request in a .NET Environment, providing at least one Data Management Response in the .NET Environment in response to the Data Management Request(s), adapting the Data Management Response(s) into at least one corresponding Data Management Response in the COM Environment, and posting the Data Management Response(s) to the MAPI Client Component via the MAPI.

In one embodiment the Software System of the invention comprises at least one MAPI Client Component operating in a COM Environment, a Software Mediator operating partly in the COM Environment and partly in a .NET Environment, and at least one Corporate System operating in the .NET Environment. The MAPI Client Component(s) is capable of posting at least one Service Request in COM to the Software Mediator via a MAPI. The Software Mediator is capable of adapting the Service Request(s) in COM Environment, into at least one corresponding Service Request in .NET Environment, and of posting the Service Request(s) in .NET Environment to the Corporate System(s). The Corporate System(s) is capable of posting at least one Response to the Service Request(s) in .NET Environment. The Software Mediator is capable of adapting the Response(s) in .NET to at least one corresponding Response in COM, and to post the Response(s) to the MAPI Client Component(s) via the MAPI (Messaging Application Programming Interface).

In one embodiment the Software Mediator comprises a Model Adapter, at least one Model Provider and at least one System Adapter, which optionally may be integrated with the Model Provider.

In one embodiment the Software Mediator comprises a Model Adapter, at least one Model Provider and at least one of the Corporate Systems comprises an integrated System Adapter.

In one embodiment the Software Mediator further comprises a Client Adapter.

In one embodiment the Software System of the invention comprises at least one MAPI Client Component operating in a COM Environment, a Client Adapter with the ability to subscribe to events on one or more Corporate System(s), a Software Mediator operating partly in the COM Environment and partly in a .NET Environment, and at least one Corporate System operating in the .NET Environment. At least one of the Corporate System(s) is capable of processing an event and generating one or more Request(s) to the Client Adapter The Client Adapter generates one or more Request(s) to the MAPI Client Component(s). The MAPI Client Component(s) is capable of posting at least one Service Request in COM to the Software Mediator via a MAPI. The Software Mediator is capable of adapting the Service Request(s) in COM Environment, into at least one corresponding Service Request in .NET Environment, and of posting the Service Request(s) in .NET Environment to the Corporate System(s). The Corporate System(s) is capable of posting at least one Response to the Service Request(s) in .NET Environment. The Software Mediator is capable of adapting the Response(s) in .NET to at least one corresponding Response in COM, and to post the Response(s) to the MAPI Client Component(s) via the MAPI (Messaging Application Programming Interface).

In one embodiment the Software System of the invention comprises at least one MAPI Client Component(s) operating in a COM Environment, a Software Mediator operating partly in the COM Environment and partly in a .NET Environment, and at least one Corporate System operating in a Third Environment other than COM, and .NET, the MAPI Client Component(s) is capable of posting at least one Service Request in COM to the Software Mediator via a MAPI (Messaging Application Programming Interface). The Software Mediator is programmed to adapt the Service Request(s) in COM to corresponding Service Request(s) in .NET and further to corresponding Service Request(s) in the Third Environment. The Corporate System(s) is capable of posting at least one Response to the Service Request(s) in the Third Environment. The Software Mediator is capable of adapting the Response(s) in the Third Environment to at least one corresponding Response in .Net and further to at least one corresponding Response(s) in COM, and to post the Response(s) to the MAPI Client Component(s) via the MAPI (Messaging Application Programming Interface).

In one embodiment the Software System of the invention comprises at least one MAPI Client Component(s), a Software Mediator, and at least one Corporate System acting as a Service Provider. The MAPI Client Component(s) is capable of posting at least one Service Request to the Software Mediator via a MAPI (Messaging Application Programming Interface). The Software Mediator is programmed to adapt the Service Request(s) acting as a Service Requestor to a corresponding Service Request(s) to the Service Provider in the form of a Web Service. The Corporate System(s) is capable of posting at least one Response to the Service Request(s). The Software Mediator is capable of adapting the Response(s) to at least one corresponding Response and to post the Response(s) to the MAPI Client Component(s) via the MAPI (Messaging Application Programming Interface).

In one embodiment the Software System of the invention comprises at least one MAPI Client Component(s), a Software Mediator, a Corporate System acting as a Service Broker and at least one Corporate System implementing a Service Provider service. The MAPI Client Component(s) is capable of posting at least one Service Request to the Software Mediator via a MAPI (Messaging Application Programming Interface). The Software Mediator is programmed to send a Service Request(s) to the Service Broker. The Service Broker is capable of posting at least one Response to the Service Request(s) containing information on the Service Provider. The Software Mediator is programmed to adapt the Service Request(s) acting as a Service Requestor to a corresponding Service Request(s) to the Service Provider in the form of a Web Service. The Corporate System(s) is capable of posting at least one Response to the Service Request(s). The Software Mediator is capable of adapting the Response(s) to at least one corresponding Response and to post the Response(s) to the MAPI Client Component(s) via the MAPI (Messaging Application Programming Interface).

In one embodiment the Software Mediator acting as a Service Requestor posting one or more Service Requests to a Service Broker to find a suitable Service Provider. The Requests to the Service Broker are sent through a protocol known as UDDI (Universal Description Discovery and Integration).

### BRIEF DESCRIPTION OF DRAWINGS

The invention will be explained more fully below in connection with a preferred embodiment and with reference to the drawings in which:

FIG. 1 is a schematic illustration of a Software System of the invention

FIG. 2 is a schematic illustration of the Model Provider Interfaces. The Object Provider is the basic interface common to the other three interfaces. The Object Provider Interfaces is specialized by the Library Provider Interface which in turn is specialized by the Container Provider Interface. The Object Provider Interfaces is further specialized by the Item Provider Interface.

FIG. 3 is a schematic illustration of the associations between Model Provider Interfaces. From implementations of the Library Provider Interface implementations of the Container Provider Interface may be deduced. From implementations of the Container Provider Interface other implementations of the Container Provider Interface and implementations of the Item Provider Interface may be deduced. From implementations of the Item Provider Interface other implementations of the Item Provider Interface may be deduced.

FIG. 4 is a schematic illustration of the Item Provider Interface implemented as Address Provider, Contact Provider, Mail Provider, Category Provider, Recipient Provider, and Attachment Provider.

FIG. 5 is a schematic illustration of a Mail Provider implementation with associated Category Provider, Recipient Provider, and Attachment Provider implementations in union providing complex mail items.

FIG. 6 is a schematic illustration of the System Adapter Interface implemented as Microsoft SQL Server Adapter, Microsoft SharePoint Adapter, Microsoft Dynamics AX Adapter, Microsoft Dynamics NAV Adapter, SAP mySAP Adapter, and Oracle Financials Adapter.

FIG. 7 is a schematic illustration of a Software System of the invention.

FIG. 8 is an illustration of a Microsoft Outlook® tree view.

FIG. 9 is an illustration of a Microsoft Outlook® list view.

### EXAMPLES 1

In a prior art example, a sales representative receives an email in her email system from a client claiming that an order fulfillment is late. She consults her customer relationship management (CRM) system to inspect the list of pending issues, her order management (OM) system to inspect the current order tracking, and once again her CRM system to possibly record the current issue.

As she receives and reads the mail, she double-clicks the email-sender object and from the sender-properties window she copies his email address. She then logs-in to her CRM system where she navigates to the contacts section to search the contact mailing her. She pastes the email address copied and finds the contact. From the contact window she then opens the company window and from the company window she opens the list of issues and informs herself about the pending issues. The sales representative then copies the company id from the company window previously opened, logs-in to her OM system, and navigates to the companies section to search the company. She pasts in the copied company id and finds the company. From the company window she opens the order tracking window and informs herself about the current order tracking. The sales representative then switches back to her CRM system and enters a new issue. And finally the sales representative switches back to her email system from where she replies on the email. The sales representative is switching between, logging-in to, and navigating three different applications.

In an example of the invention, the sales representative consults her client issue and order tracking data inside her Microsoft Outlook Explorer.

As she receives and reads the mail, she right-clicks the email-sender object and from the context menu chooses to see pending customer issues. The system automatically deduces the company from the contact, searches all issues related to the company, displays the found issues in a Microsoft Outlook Explorer view pane, and shifts the Microsoft Outlook Explorer user interface focus to the customer issues view pane. The sales representative informs herself about the pending issues, then right clicks the company object in the customer issues view pane, and from the context menu chooses to see the latest order tracking data. The system automatically searches all order tracks related to the customer, displays the found order tracks in a Microsoft Outlook Explorer view pane, and shifts the Microsoft Outlook Explorer user interface focus to the order tracking view pane. The sales representative informs herself about the order status, hits the Microsoft Outlook Explorer Back-button to refocus on the issues view pane, and enters a new issue. The sales representative yet again hits the Microsoft Outlook Explorer Back-button to refocus on her email inbox and replies on the email. The sales representative performs the entire task within the Microsoft Outlook Explorer, automatically logs-in to all systems, and easily navigates from email, over pending issues to order tracking, and back.

In both the above examples, applications are connected directly or indirectly to the corporate network through which corporate data is retrieved and stored in corporate databases. Data is retrieved by desktop or laptop PCs merely for the purpose of presentation to the end user and is never stored on desktop or laptop hard disks. Such architecture supports access to large data volumes without impacting the corporate network and corporate systems unnecessarily, without leaving traces of possibly sensitive data on desktop or laptop hard disks, and without unnecessary delays in publishing data updates to other users.

Creating solutions that manage corporate data as described above and allowing corporate employees to manage their tasks entirely from within the Microsoft Outlook Explorer using legacy COM (Component Object Model) technologies is possible but requires expert programming knowledge and is very time consuming to achieve. To manage data inside the Microsoft Outlook Explorer programmers must implement the Microsoft messaging application programming interface (MAPI). MAPI has existed since 1991 and Microsoft Outlook has supported MAPI since its first version. MAPI operates in COM, is very extensive, and is largely un-documented. Creating solutions operating inside the Microsoft Outlook Explorer using the innovative and much easier to use .NET technologies has previously not been possible.

### EXAMPLE 2

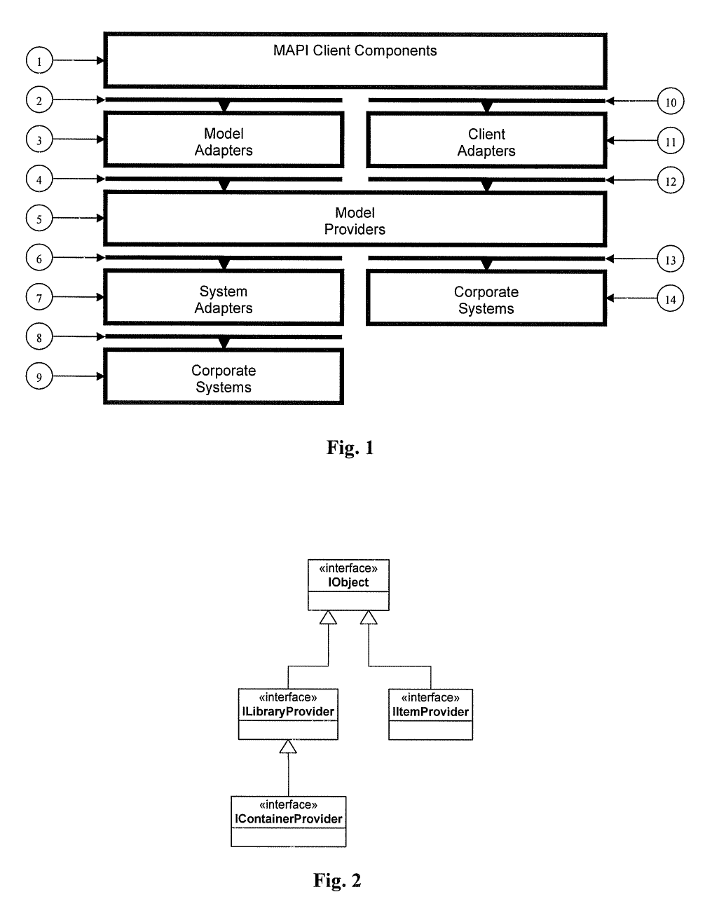

FIG. 1 illustrates a preferred embodiment of the invention and it also illustrates a way to implement the invention as explained below.

The Software System comprises one or more MAPI Client Components 1 such as Microsoft Outlook, Mozilla Thunderbird, QUALCOMM Eudora, and Novell Groupwise. These MAPI clients are available on market and are well known to the skilled person.

The Software System comprises one or more Model Adapters 3, such as an Address Book Adapter, a Message Store Adapter, and a Message Transport Adapter.

The Software System comprises one or more Model Providers 5, such as Library Providers, Container Providers, Item Providers, and numerous specializations hereof—In the examples below these providers is referred to as providers 5. The mapping of these concepts into MAPI Client Components 1 is provided by the invention and is the responsibility of Model Adapters (3).

The Software System comprises one or more System Adapters 7 comprising System Adapters optionally including numerous specializations hereof. The usage of System Adapters by Model Providers is the responsibility of Model Providers.

The Software System comprises one or more Corporate Systems 9, 14 such as Microsoft SQL Server, Microsoft SharePoint, Microsoft Dynamics AX, Microsoft Dynamics NAV, SAP mySAP, and Oracle Financials. Such systems are available on market and are well known to the skilled person. The mapping between Corporate Systems 9, 14 and Model Providers 5 is provided by the invention and is in one embodiment the responsibility of System Adapters 7 and in another embodiment the responsibility of Model Providers 5.

The Software System comprises one or more Client Adapters 11 such as the Microsoft Outlook Adapter, the Mozilla Thunderbird Adapter, the QUALCOMM Eudora Adapter, and the Novell Groupwise Adapter. Such systems are available on market and are well known to the skilled person.

Model Providers 5 may exhibit capabilities such as the ability to insert, update, delete and other features and exhibit model such as columns of data, data type, and other characteristics. The mapping of these capabilities and models into alterations of MAPI Client Components 1 is provided by the invention and is the responsibility of Client Adapters 11.

### EXAMPLES 3

The following examples illustrate such MAPI Service Provider Interfaces being implemented by Model Adapters 3:

Referring again FIG. 1. MAPI Client Components 1 operating in COM request services via MAPI Service Provider Interfaces 2 from Model Adapters 3. Model Adapters 3 service requests from MAPI Client Components 1 by implementing MAPI Service Provider Interfaces 2. Implementations of MAPI Service Provider Interfaces 2 are programmed in C++ and operate in the COM environment.

IMAPIContainer::GetHierarchyTable( ) is implemented to provide MAPI Client Components 1 with a table, an implementation of IMAPITable, constructed to hold references to associated Container Providers 5.

IMAPIContainer::GetContentsTable( ) is implemented to provide MAPI Client Components 1 with a table, an implementation of IMAPITable, constructed to hold references to associated Item Providers 5.

IMAPITable::QueryColumns( ) is implemented to provide MAPI Client Components 1 with visibility into properties/attributes provided by associated Container or Item Providers 5.

IMAPITable::SetColumns( ) is implemented to provide MAPI Client Components 1 with the ability to order and restrict the number of columns to be provided by associated Container or Item Providers 5.

IMAPITable::Restrict( ) is implemented to provide MAPI Client Components 1 with the ability to restrict the number of rows to be provided by associated Container or Item Providers 5.

IMAPITable::SortTable( ) is implemented to provide MAPI Client Components 1 with the ability to order the rows to be provided by associated Container or Item Providers 5.

IMAPITable::GetRowCount( ) is implemented to provide MAPI Client Components 1 with a count of rows in associated Container or Item Providers 5. This count of rows is made subject to the restrictions set in IMAPITable::Restrict( ).

IMAPITable::SeekRow( ) is implemented to provide MAPI Client Components 1 with the ability to set the row offset in preparation for the IMAPITable::QueryRows( ) method.

IMAPITable::QueryRows( ) is implemented to provide MAPI Client Components 1 with a number of rows (items) from associated Container or Item providers 5. These rows are subject the restriction set in IMAPITable::Restrict( ), the order set in IMAPITable::SortTable( ) and the row offset set in IMAPITable::SeekRow( ).

In most but not all of the examples above associated providers 5 are referenced for the purpose of constructing and associating other providers, for the purpose of reflecting upon capabilities and model, for the purpose of preparing for restrictions and sort orders, and for the purpose of requesting row count and row sets.

MAPI Service Provider Interfaces 2 operate in COM and Model Provider Interfaces 4 operate in .NET. Model Adapters 3 perform data marshalling form COM to .NET on incoming parameters and from .NET to COM on outgoing parameters. Every component invoked by a MAPI call runs in the threads of the MAPI Client Component and thus are all developed and marked as free-threaded (a.k.a. thread-safe).

### EXAMPLE 4

Model Adapters 3 request services via Model Provider Interfaces 4 from Model Providers 5. Model Adapters 3 and Model Providers 5 all operate in the .NET environment. Model Providers 5 are implementations of Model Provider Interfaces 4.

Model Adapters 3 reflect upon Model Provider 5 capabilities to prevent requesting services from but not supported by the Model Providers 5.

Model Provider Interfaces 4 comprise the Object Provider interface, the Library Provider interface, the Container Providers interface, and the Item Providers interface. Model Providers have attributes expressed through hash tables (index-able collections of name/value pairs).

The Object Provider interface is the basic interface defining common provider attributes and methods. The Container Provider interface is a specialization of the Library Provider interface, which in turn is a specialization of the Object Provider interface. The Item Provider interface is equally a specialization of the Object Provider interface. This is illustrated in FIG. 2.

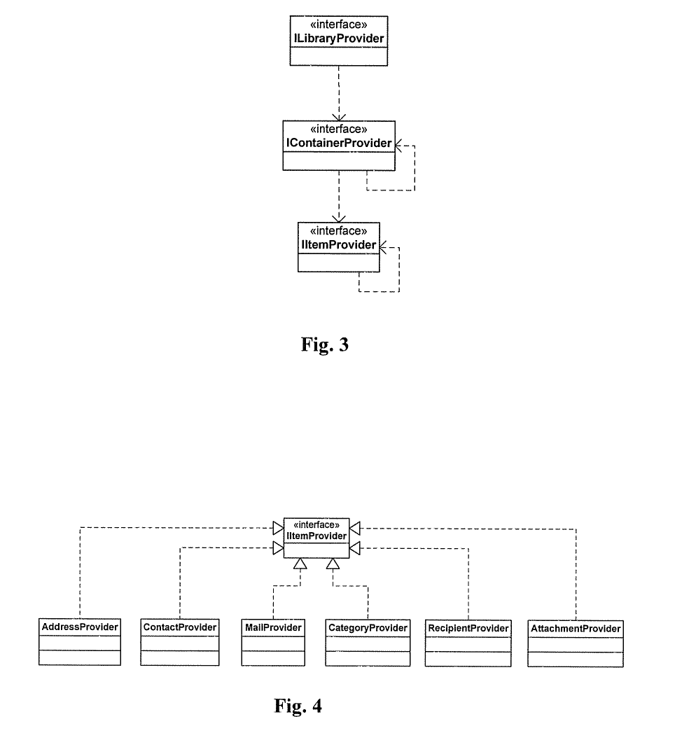

Libraries have (are associated to) containers, which in turn have sub containers and items. Items have sub items allowing for construction of complex classes. This is illustrated in FIG. 3.

Model Provider Interfaces 4 follow a pattern. Model Providers 5 all provide reflection upon provider capabilities, reflection upon protocol supported by provider, take context settings, take behavioral settings, provide objects of various specializations by the item, by the page, and by the full set. The Library Provider Interface also provides references to Container Providers, the Container Provider interface provides references to Item Providers and sub Container Providers, while the Item Provider Interface provides references to sub Item Providers.

Specialization of Model Providers 5 is introduced through their implementation. Item Providers are in one embodiment implemented as Address Provider, Contact Provider, Mail Provider, Category Provider, Recipient Provider, and Attachment Provider. This is illustrated in FIG. 4.

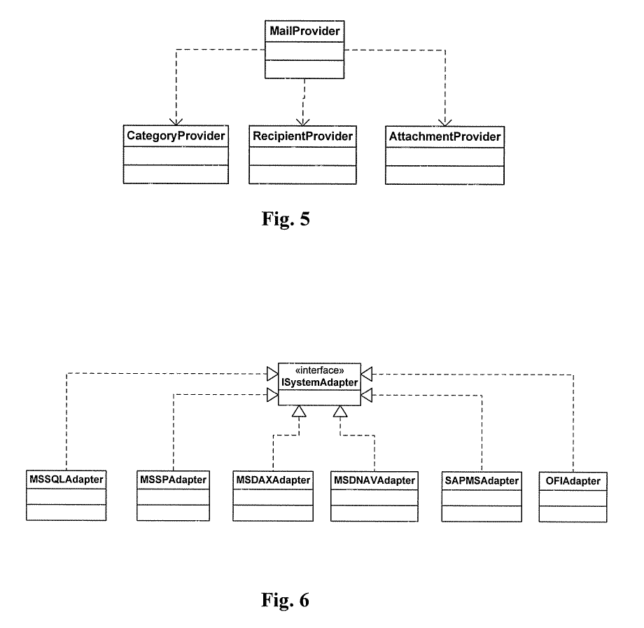

In one embodiment, mails have categories, recipients, and attachments forming complex classes. This is illustrated in FIG. 5.

Model specialization is contracted between Model Adapters 3 and Model Providers 5 through protocol. Contracts on class and attributes names form the basis of the protocol. Rules defining presence of object attributes and item sub items extend the protocol. In one embodiment mandatory mail attributes may comprise the mail subject and optional MAIL attributes may comprise the mail importance.

Model Adapters 3 are developed with varying degrees of tolerance to non-compliance to protocol. In one embodiment Model Adapters 3 may operate with reduced functionality when Model Providers 5 are non-compliant to protocol. In another embodiment Model Adapters 3 may reject to operate at all when Model Providers 5 are non-compliant to protocol. Reflection upon the protocol provided by the Model Providers 5 dictated by the Model Provider Interfaces 4 allows Model Adaptors 3 to detect compliance and non-compliance to protocol early and act accordingly.

### EXAMPLE 5

In one embodiment, Model Providers 5 request services via System Adapter Interfaces 6 from System Adapters 7. Model Providers 5 and System Adapters 7 all operate in the .NET environment. System Adapters 7 are implementations of System Adapter Interfaces 6.

Model Adapters 5 reflect upon System Adapter 7 capabilities to exhibit their own capabilities. If and when System Adapters 7 do not support a certain feature, Model Adapters 5 may in one embodiment transmit non-support and in another embodiment implement support for the feature within the System Adapter 7 itself.

The System Adapter Interface 6 provides reflection upon adapter capabilities, reflection upon data model supported by the corporate system, take parameters, take behavioral settings, provide data records by the item, by the page, and by the full set.

Specialization of System Adapters 7 is introduced through implementation. System Adapters are in one embodiment implemented as Microsoft SQL Server Adapter, Microsoft SharePoint Adapter, Microsoft Dynamics AX Adapter, Microsoft Dynamics NAV Adapter, SAP mySAP Adapter, and Oracle Financials Adapter. This is illustrated in FIG. 6.

### EXAMPLE 6

Referring to FIG. 6 as described above.

System Adapters 7 request services via standard or proprietary Corporate System Interfaces 8 from Corporate Systems 9. Corporate System Interfaces 8 vary between Corporate Systems 9. System Adapters 9 operate in the .NET environment.

### EXAMPLE 7

In one embodiment, Model Providers 5 request services via standard or proprietary Corporate System Interfaces 13 from System Adapters 14. Corporate System Interfaces 13 vary between Corporate Systems 14. MAPI Client Components 1, operating in COM, send signal events (through method calls) via Proprietary Extensibility Interfaces 10 to Client Adapters 11.

### EXAMPLE 8

Client Adapters 11 e.g. as described in Example 6 manage signals from MAPI Client Components 1 by implementing Proprietary Extensibility Interfaces 10. In one embodiment implementations of Proprietary Extensibility Interfaces 10 are programmed in C and C++ with Managed Extensions and operate in the COM environment. In another embodiment implementations of Proprietary Extensibility Interfaces (10) are programmed in C# and operate in the .NET environment.

In one embodiment a technique commonly referred to as the Shim is used to perform data marshalling (adaptation between COM and .NET environments) between Microsoft Outlook 2003, in place of MAPI Client Components, and the Outlook Client Adapter, in place of Client Adapters. The Outlook Client Adapter is programmed in C# and operates in the .NET Environment. The Outlook Client Adapter implements the Microsoft Outlook 2003 Extensibility Interfaces.

The following examples illustrate such Microsoft Outlook 2003 Extensibility Interfaces being implemented by the Outlook Client Adapter 11: Application.NameSpace.Folders.FolderChange( ) is implemented to enable and disable toolbars and menus, such that actions supported by Folder Providers 5 providing the selected folder are enabled while actions not supported by same Folder Providers 5 are disabled.

Application.Inspectors.NewInspector( ) is implemented to intercept the opening of inspectors for the purpose of opening alternative custom inspectors, when messages (items) of non-Outlook-native message classes are opened.

Application.ActiveExplorer.CommandBars.OnUpdate( ) is implemented to decorate context menus (inserting new menu entries and disabling other menu entries).

In all of these examples, the Microsoft Outlook 2003 object model is referenced to perform the task. Microsoft Office Primary Interop Assemblies (PIA) facilitate the communication between event handlers (interface implementations) operating in the .NET environment and the Microsoft Outlook objects operating in COM.

### EXAMPLE 9

In one embodiment Library Providers 5 are implemented as the Address Book Provider and the Message Store Provider.

In one embodiment Container Providers are implemented as the Explicit Container Provider, the Implicit Container Provider, the Recursive Container Provider, the Explicit Folder Provider the Implicit Folder Provider, and the Recursive Folder Provider.

In one embodiment Item Providers are implemented as the Address Provider, the Mail Provider, the Category Provider, the Recipient Provider, the Attachment Provider, the Contact Provider, the Document Provider, the Fax Provider, the Voice Provider, the Letter Provider, the Company Provider, and the Project Provider.

### EXAMPLE 10

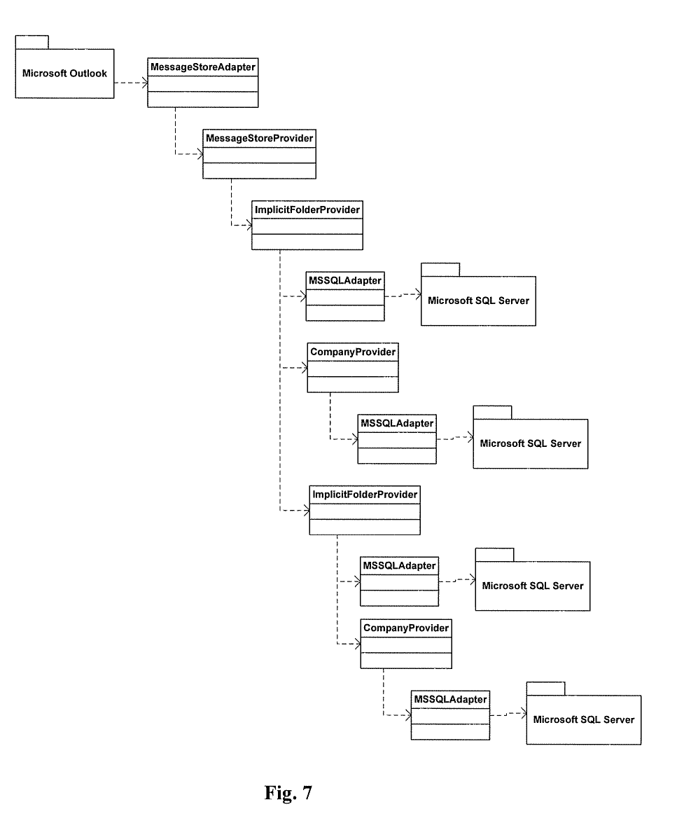

In one embodiment a solution is assembled from a MAPI Client Component 1 comprising Microsoft Outlook, a Model Adapter 3 comprising the Message Store Adapter, Model Providers 5 comprising the Message Store Provider, the Implicit Folder Provider, and the Company Provider, a System Adapter 7 comprising the Microsoft SQL Server Adapter, and a Corporate System 9 comprising Microsoft SQL Server. This is illustrated in FIG. 7.

In the same embodiment the components comprising the solution are configured as illustrated in Listing 1. Values expressed as eclipses ( . . . ) represent values that are substituted with particular connection strings to particular Microsoft SQL Servers in the corporate network.

Listing 1

```
<messageSToreAdapter>
  <mode readOnly=”true”>
</messageSToreAdapter>
<model>
  <attributes/>
  <messasgeStores
    implementation=”Quantum.Insight.Core.Model.Providers.MessageStoreProvider”>
    <messageStore caption=”My Company Application”>
      <attributes/>
      <folders
        implementation=”Quantum.Insight.Core.Model.Providers.ImpFolderProvider”>
        <parameters/>
        <system
          implementation=”Quantum.Insight.MSSQL.System.Adapters.MSSQLAdapter”>
          <query
            connection=”...”
            select=”Name, Code”
            from=”Countries”/>
        </system>
        <folder caption=”&Name”>
          <attribtes>
            <attribute name=”CountryCode” type=”Integer” value=”&Code”>
          </attribtes>
          <items
            implementation=”Quantum.Insight.Model.CompanyProvider”>
            <parameters>
              <parameter name=”1” value=”&.CountryCode”>
            </parameters>
            <system
              implementation=”Quantum.Insight.MSSQL.System.Adapters.MSSQLAdapter”>
              <query
                connection=”...”
                select=”C.Id, C.Name, C.Address, C.Zip, C.Phone,
                      C.Created, R.Name”
                from=”Companies C JOIN Regions R
                    ON Companies.RegionCode = Regions.Code”
                where=”CountryCode=@1”/>
            </system>
            <item
              key=”&C.Id” class=”Company” name=”&C.Name”
              address=”&C.Address”, phone=”&C.Phone”>
              <attributes>
                <attribute name=”Created” type=”Date” value=”&C.Created”/>
                <attribute name=”Region” type=”String” value=”&R.Name”/>
              </attributes>
            </item>
          </items>
          <folders
            mplementation=”Quantum.Insight.Core.Model.Providers.ImpFolderProvider”>
            <parameters>
              <parameter name=”1” value=”&.CountryCode”>
            </parameters>
            <system
              implementation=”Quantum.Insight.MSSQL.System.Adapters.MSSQLAdapter”>
              <query
                connection=”...”
                select=”Name, Code”
                from=”Regions”
                where=”CountryCode=@1”/>
            </system>
            <folder caption=”&Name”>
              <attributes>
                <attribute name=”RegionCode” type=”Integer” value=”&Code”/>
              </attributes>
              <items
                implementation=”Quantum.Insight.Model.CompanyProvider”>
                <parameters>
                  <parameter name=”1” value=”&..CountryCode”>
                  <parameter name=”2” value=”&.RegionCode”>
                </parameters>
                <system
                  implementation=”Quantum.Insight.MSSQL.System.Adapters.MSSQLAdapter”>
                  <query
                    connections=”...”
                    selects=”Id, Name, Address, Zip, Phone, Created”
                    froms=”Companies”
                    where=”CountryCode=@1 AND RegionCode=@2”/>
                </system>
                <item
                  key=”&Id” class=”Company” name=”&Name”
                  address=”&Address”, phone=”&Phone”>
                  <attributes>
                    <attribute name=”Created” type=”Date” value=”&Created”/>
                  </attributes>
                </item>
              </items>
            </folder>
          </folders>
        </folder>
      </folders>
    </messageStore>
  </messageStores>
</model>
```

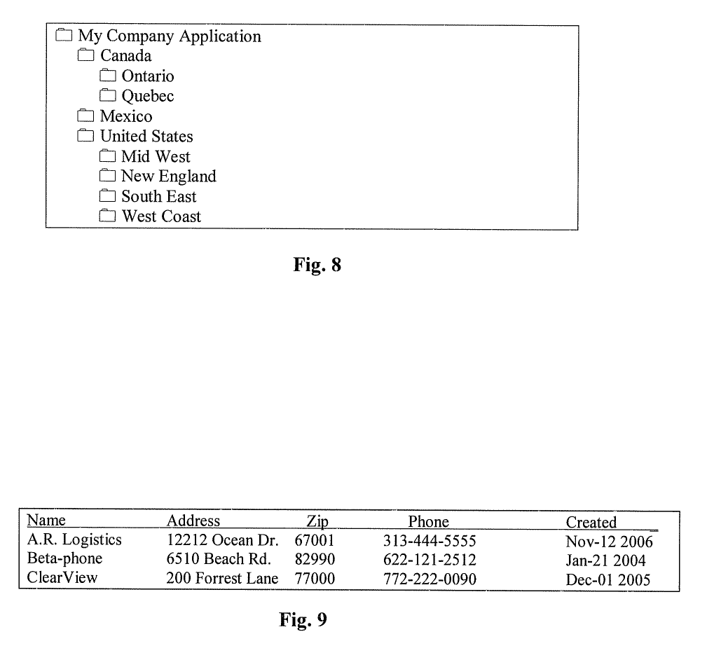

In the same embodiment users are at some point in time seeing the Microsoft Outlook tree view as illustrated in FIG. 8. As users click on the South East folder they are at some point in time seeing the Microsoft Outlook list view as illustrated in FIG. 9.

Some preferred embodiments have been shown in the foregoing, but it should be stressed that the invention is not limited to these, but may be embodied in other ways within the scope of the invention.

1. A Software System comprising at least one MAPI Client Component, a Model Adapter, and a Model Sub System, said MAPI Client Component(s) operating in a COM Environment, said Model Adapter operating partly in said COM Environment and partly in a .NET Environment, said Model Sub System operating partly or fully in said .NET Environment, and said MAPI Client Component(s), said Model Adapter, and said Model Sub System being arranged to communicate with each other.

2. A Software System as claimed in claim 1 wherein said Model Sub System comprises at least one Database.

3. A Software System as claimed in claim 1 further comprising at least one Client Adapter, said Client Adapter(s) operating partly in said COM Environment and partly in said .NET Environment, and said MAPI Client Component(s), said Client Adapter, and said Model Sub System being arranged to communicate with each other.

4. A Software System as claimed in claim 1 wherein said MAPI Client Component(s) being capable of posting at least one Data Management Request to said Model Adapter via a MAPI (Messaging Application Programming Interface), said Model Adapter being capable of receiving said Data Management Request(s) posted from said MAPI Client Component(s), of adapting said Data Management Request(s) received, and of posting said adapted Data Management Request(s) to said Model Sub System, and said Model Sub System being capable of receiving said Data Management Request(s) posted from said Model Adapter and of processing said Data Management Request(s) received.

5. A Software System as claimed in claim 4 wherein said Model Sub System being capable of providing at least one Data Management Response in response to said Data Management Request(s) received and of posting said provided Data Management Response(s) to said Model Adapter, said Model Adapter being capable of receiving said Data Management Response(s) posted from said Model Sub System, of adapting said Data Management Response(s) received, and of posting said adapted Data Management Response(s) to said MAPI Client Component(s) via said MAPI, and said MAPI Client Component(s) being capable of receiving said Data Management Response(s) posted from said Model Adapter and of processing said Data Management Response(s) received.

6. A Software System as claimed in claims 4 wherein said Data Management Request(s) comprises at least one Data Count Request.

7. A Software System as claimed in claims 4 wherein said Data Management Request(s) comprises at least one Data Select Request.

8. A Software System as claimed in claim 4 wherein said Data Management Request(s) comprises at least one Data Insert Request.

9. A Software System as claimed in claim 4 wherein said Data Management Request(s) comprises at least one Data Update Request.

10. A Software System as claimed in claim 4 wherein said Data Management Request(s) comprises at least one Data Delete Request.

11. A Software System as claimed in claims 5 wherein said Data Management Response(s) comprises at least one Data Count Response.

12. A Software System as claimed in claims 5 wherein said Data Management Response(s) comprises at least one Data Select Response.

13. A Software System as claimed in claim 5 wherein said Data Management Response(s) comprises at least one Data Insert Response.

14. A Software System as claimed in claim 5 wherein said Data Management Response(s) comprises at least one Data Update Response.

15. A Software System as claimed in claim 5 wherein said Data Management Response(s) comprises at least one Data Delete Response.

16. A Software System as claimed in claim 3 wherein said MAPI Client Component(s) being capable of posting at least one State Change Signal to said Client Adapter, said Client Adapter being capable of receiving said State Change Signal(s) posted from said MAPI Client Component(s), of reacting to said State Change Signal(s) received by posting at least one Service Level Request to said Model Sub System, said Model Sub System being capable of receiving said Service Level Request(s) posted from said Client Adapter(s), of providing at least one Service Level Response in response to said Service Level Request(s) received, and of posting said provided Service Level Response(s) to said Client Adapter, and said Client Adapter being capable of receiving said Service Level Response(s) posted from said Model Sub System, and of augmenting, altering, and/or diminishing at least one User Interface Element of said MAPI Client Component(s) based on said Service Level Response(s) received.

17. A Software System as claimed in claim 1 wherein said Model Sub System comprises at least one Model Provider, at least one System Adapter, and at least one Corporate System, said model Provider(s) operating in said .NET Environment, and said System Adapter(s) operating partly or fully in said .NET Environment and optionally partly in a Third Environment, said Corporate System(s) operating at least partly in said .Net Environment or at least partly in said Third Environment.

18. A Software System as claimed in claim 17 wherein said Corporate System(s) comprises at least one Database.

19. A software System as claimed in claim 17 wherein said System Adaptor(s) being partly or fully integrated into said Corporate System(s).

20. A Software System as claimed in claim 19 wherein said Model Provider(s) being capable of receiving at least one Service Request selected from the group consisting of said Data Management Request(s) and said Service Level Request(s) and posted from said Model Adapter or said Client Adapter respectively, of decomposing said Service Request(s) received, of adapting said decomposed Service Requests(s), and of posting said adapted Service Request(s) to said Corporate System(s), and said Corporate System(s) being capable of receiving said Service Request(s) posted from said Model Provider(s), and of processing said Service Request(s) received.

21. A Software System as claimed in claim 20 wherein said Corporate System(s) being capable of providing at least one Service Response in response to said Service Request(s) received, and of posting said provided Service Response(s) to said Model Provider(s), and said Model Provider(s) being capable of receiving said Service Response(s) posted from said Corporate System(s), of adapting said Service Request(s) received, of composing said adapted Service Response(s), and of posting said composed Service Response(s) to said Model Adapter or said Client Adapter.

22. A Software System as claimed in claims 20 wherein said Service Request(s) comprises at least one Data Count Request.

23. A Software System as claimed in claims 20 wherein said Service Request(s) comprises at least one Data Select Request.

24. A Software System as claimed in claim 20 wherein said Service Request(s) comprises at least one Data Insert Request.

25. A Software System as claimed in claim 20 wherein said Service Request(s) comprises at least one Data Update Request.

26. A Software System as claimed in claim 20 wherein said Service Request(s) comprises at least one Data Delete Request.

27. A Software System as claimed in claims 21 wherein said Service Response(s) comprises at least one Data Count Response.

28. A Software System as claimed in claims 21 wherein said Service Response(s) comprises at least one Data Select Response.

29. A Software System as claimed in claim 21 wherein said Service Response(s) comprises at least one Data Insert Response.

30. A Software System as claimed in claim 21 wherein said Service Response(s) comprises at least one Data Update Response.

31. A Software System as claimed in claim 21 wherein said Service Response(s) comprises at least one Data Delete Response.

32. A Software System as claimed in claim 17 wherein said Model Provider(s) being capable of receiving at least one Service Request selected from the group consisting of said Data Management Request(s) and said Service Level Request(s) and posted from said Model Adapter or said Client Adapter respectively, of decomposing said Service Request(s) received, and of posting said decomposed Service Request(s) to said System Adapter(s), said System Adapter(s) being capable of receiving said Service Request(s) posted from said Model Provider(s), of adapting said Service Request(s) received, and of posting said adapted Service Request(s) to said Corporate System(s), and said Corporate System(s) being capable of receiving said Service Request(s) posted from said System Adapter(s), and of processing said Service Request(s) received.

33. A Software System as claimed in claim 32 wherein said Software comprises n System Adaptor(s) wherein n is at least two, and wherein a first System Adaptor being capable of receiving said Service Request(s) posted from said Model Provider(s) and of posting said received Service Request(s) to another System Adaptor, said Service Request(s) being posted to and received by a total of n System Adaptors, at least one of the System Adaptors being capable of adapting said Service Request(s), wherein the n'th System Adaptor being capable of posting said adapted Service Request(s) to said Corporate System(s).

34. A Software System as claimed in claim 33 wherein said Corporate System(s) being capable of providing at least one Service Response in response to said Service Request(s) received, and of posting said provided Service Response(s) to said n'th System Adaptor, said n'th System Adaptor being capable of receiving said Service Response(s) posted from said Corporate System(s) and of posting said received Service Response(s) to another System Adaptor, said Service Response(s) being posted to and received by said n System Adaptors, at least one of the System Adaptors being capable of adapting said Service Response(s) received, wherein said first System Adaptor being capable of posting said adapted Service Response(s) to said Model Provider(s).

35. A Software System as claimed in claim 32 wherein said Corporate System(s) being capable of providing at least one Service Response in response to said Service Request(s) received, and of posting said provided Service Response(s) to said System Adapter(s), said System Adapter(s) being capable of receiving said Service Response(s) posted from said Corporate System(s), of adapting said Service Response(s) received, and of posting said adapted Service Response(s) to said Model Provider(s), and said Model Provider(s) being capable of receiving said Service Response(s) posted from said System Adapter(s), of composing said Service Response(s) received, and of posting said composed Service Response(s) to said Model Adapter or said Client Adapter.

36. A Software System as claimed in claims 31 wherein said Service Request(s) comprises at least one Data Count Request.

37. A Software System as claimed in claims 31 wherein said Service Request(s) comprises at least one Data Select Request.

38. A Software System as claimed in claim 31 wherein said Service Request(s) comprises at least one Data Insert Request.

39. A Software System as claimed in claim 31 wherein said Service Request(s) comprises at least one Data Update Request.

40. A Software System as claimed in claim 31 wherein said Service Request(s) comprises at least one Data Delete Request.

41. A Software System as claimed in claims 32 wherein said Service Response(s) comprises at least one Data Count Response.

42. A Software System as claimed in claims 32 wherein said Service Response(s) comprises at least one Data Select Response.

43. A Software System as claimed in claim 32 wherein said Service Response(s) comprises at least one Data Insert Response.

44. A Software System as claimed in claim 32 wherein said Service Response(s) comprises at least one Data Update Response.

45. A Software System as claimed in claim 32 wherein said Service Response(s) comprises at least one Data Delete Response.

46. A Software System as claimed in claim 1 wherein said Model Adapter having configurable behavior, and comprises at least one configuration schema for said Model Adapter, and configuration for said Model Adapter preferably being retrieved from at least one source chosen from the group of messages, XML-files, Directory Services, and Relational Databases.

47. A Software System as claimed in claim 3 wherein said Client Adapter having configurable behavior, and comprises at least one configuration schema for said Client Adapter, and configuration for said Client Adapter preferably being retrieved from at least one source chosen from the group of messages, XML-files, Directory Services, and Relational Databases.

48. A Software System as claimed in claim 17 wherein said Model Provider(s) having configurable behavior, and comprises at least one configuration schema for said Model Provider(s), and configuration for said Model Provider(s) preferably being retrieved from at least one source chosen from the group of messages, XML-files, Directory Services, and Relational Databases.

49. A Software System as claimed in claim 17 wherein said System Adapter(s) having configurable behavior, and comprises at least one configuration schema for said System Adapter(s), and configuration for said System Adapter(s) preferably being retrieved from at least one source chosen from the group of messages, XML-files, Directory Services, and Relational Databases.

50. A Software System as claimed in claim 1 wherein said Model Adapter having extensible behavior and extensions for said Model Adapter operating in said .NET Environment and communicating with said Model Adapter via at least one Application Programming Interface.

51. A Software System as claimed in claim 3 wherein said Client Adapter having extensible behavior and extensions for said Client Adapter operating in said .NET Environment and communicating with said Client Adapter via at least one Application Programming Interface.

52. A Software System as claimed in claim 17 wherein said Model Provider(s) having extensible behavior and extensions for said Model Provider(s) operating in said .NET Environment and communicating with said Model Provider(s) via at least one Application Programming Interface.

53. A Software System as claimed in claim 17 wherein said System Adapter(s) having extensible behavior and extensions for said System Adapter(s) operating in said .NET Environment and communicating with said System Adapter(s) via at least one Application Programming Interface.

54. A Software System as claimed in claim 1 wherein said MAPI Client Component(s) is selected from the group of Microsoft Outlook®, QUALCOMM Eudora®, Novell Groupwise®, and Mozilla Thunderbird®.

55. A Software System as claimed in claim 54 wherein said MAPI Client Component(s) is selected from the group of Microsoft Outlook® 2000, Microsoft Outlook® XP, Microsoft Outlook® 2003, and Microsoft Outlook 2007.

56. A Software System as claimed in claim 17 wherein said Corporate System(s) is selected from the group consisting of a Microsoft SQL Server®, Microsoft Access®, Microsoft Dynamics CRM®, Microsoft Dynamics AX®, Microsoft Dynamics NAV®, Microsoft Dynamics GP®, Microsoft Dynamics Point of Sale®, Microsoft Dynamics RMS®, Microsoft Dynamics SL®, Microsoft SharePoint®, Microsoft Active Directory Server®, Oracle PeopleSoft®, Oracle Siebel®, Oracle JD Edwards®, SAP®, mySAP®, SAP Business One®, SAP NetWeaver®, DUET®, IBM DB2®, IBM DB2 Common Store®, IBM DB2 Content Manger®, IBM DB2 Content Manger OnDemand®, IBM DB2 Document Manger®, IBM DB2 Warehouse®, IBM FileNet®, IBM OMNIFind®, IBM Lotus Notes®, IBM Lotus Domino®, IBM Rational Suite®, IBM Tivoli®, IBM WebSphere® and IBM Workplace®.

57. A Software System as claimed in claim 1 comprising one or more off-line stores configured to provide the Software System with the ability to operate in and to switch between on-line mode and off-line mode with one or more Corporate System(s).

58. A Software System comprising one or a set of software components communicating with each other and capable of receiving at least one Data Management Request from a MAPI Client Component in a COM Environment via a MAPI (Messaging Application Programming Interface) and of adapting said Data Management Request(s) into at least one corresponding Data Management Request in a .NET Environment, providing at least one Data Management Response in said .NET Environment in response to said Data Management Request(s), adapting said Data Management Response(s) into at least one corresponding Data Management Response in said COM Environment, and posting said Data Management Response(s) to said MAPI Client Component via said MAPI (Messaging Application Programming Interface).

59. A Software System comprising at least one MAPI Client Component operating in a COM Environment, a Software Mediator operating partly in said COM Environment and partly in a .NET Environment, and at least one Corporate System operating in said .NET Environment, said MAPI Client Component(s) being capable of posting at least one Service Request in COM to said Software Mediator via a MAPI (Messaging Application Programming Interface), said Software Mediator being capable of adapting said Service Request(s) in COM Environment, into at least one corresponding Service Request in .NET Environment, and of posting said Service Request(s) in .NET Environment to said Corporate System(s), said Corporate System(s) being capable of posting at least one Response to said Service Request(s) in .NET Environment, said Software Mediator being capable of adapting said Response(s) in .NET to at least one corresponding Response in COM, and to post said Response(s) to said MAPI Client Component(s) via said MAPI (Messaging Application Programming Interface).

60. A Software System as claimed in claim 59 comprising a Client Adapter comprising the ability to subscribe to events on one or more Corporate System(s) and wherein said at least one Corporate System being capable of processing an event and generating one or more Request(s) to said Client Adapter, said Client Adapter being capable of generating at least one Service Request(s) to said MAPI Client Component, said MAPI Client Component being capable of posting said at least one Service Request in COM to said Software Mediator via said MAPI, said Software Mediator being capable of adapting said Service Request(s) in COM Environment, into at least one corresponding Service Request in .NET Environment, and of posting said Service Request(s) in .NET Environment to said Corporate System(s), said Corporate System(s) being capable of posting at least one Response to said Service Request(s) in .NET Environment, said Software Mediator being capable of adapting said Response(s) in .NET to at least one corresponding Response in COM, and to post said Response(s) to the MAPI Client Component(s) via said MAPI (Messaging Application Programming Interface).

61. A Software System as claimed in claim 59 wherein said Corporate System being configured to acting as a Service Provider and said Software Mediator is programmed to adapt said Service Request(s) acting as a Service Requestor to a corresponding Service Request(s) to the Service Provider in the form of a Web Service.

62. A Software System as claimed in claim 59 wherein said Software Mediator being configured to acting as a Service Requestor and to post at least one Service Request to a Service to search for a suitable Service Provider, said Service Request being sent through a UDDI (Universal Description Discovery and Integration) protocol.

63. A Software System comprising at least one MAPI Client Component(s) operating in a COM Environment, a Software Mediator operating partly in said COM Environment and partly in a .NET Environment, and at least one Corporate System operating in a Third Environment other than COM, and .NET, said MAPI Client Component(s) being capable of posting at least one Service Request in COM to said Software Mediator via a MAPI (Messaging Application Programming Interface), said Software Mediator being programmed to adapt said Service Request(s) in COM to corresponding Service Request(s) in .NET and further to corresponding Service Request(s) in said Third Environment, said Corporate System(s) being capable of posting at least one Response to said Service Request(s) in said Third Environment, said Software Mediator being capable of adapting said Response(s) in said Third Environment to at least one corresponding Response in .Net and further to at least one corresponding Response(s) in COM, and to post said Response(s) to said MAPI Client Component(s) via said MAPI (Messaging Application Programming Interface).
